(19) United States
(12) Patent Application Publication
(10) Pub. No.: US 2023/0016315 A1
(43) Pub. Date: Jan. 19, 2023

(54) ELECTROCHEMICAL CELLS COMPRISING A TERNARY OXIDE MATERIAL AND RELATED SYSTEMS AND METHODS

(71) Applicant: Battelle Energy Alliance, LLC, Idaho Falls, ID (US)

(72) Inventors: Prabhat K. Tripathy, Idaho Falls, ID (US); Michael R. Shaltry, Idaho Falls, ID (US)

(21) Appl. No.: 17/812,413

(22) Filed: Jul. 13, 2022

Related U.S. Application Data
(60) Provisional application No. 63/203,237, filed on Jul. 14, 2021.

(51) Int. Cl. H01M 4/90; C25B 1/14

(52) U.S. Cl. CPC H01M 4/9033; C25B 1/14; H01M 2008/1293

(57) ABSTRACT

An electrochemical cell comprising an anode, an electrolyte adjacent to the anode, a cathode adjacent to the electrolyte, and an interconnector adjacent to the cathode. One or more of the anode, the cathode, and the interconnector comprises a ternary oxide material comprising the chemical formula of M¹ₓM²_{y}O_{z}, where M¹ is an alkali metal element or an alkaline earth metal element, M² is a platinum group metal, each of x and y is independently an integer less than or equal to 2, and z is independently an integer less than or equal to 4. A system comprising one or more electrochemical cells and methods of forming the ternary oxide material are also disclosed.

### CROSS-REFERENCE TO RELATED APPLICATION

This application claims the benefit under 35 U.S.C. § 119(e) of U.S. Provisional Patent Application Ser. No. 63/203,237, filed Jul. 14, 2021, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-1D14517 awarded by the United States Department of Energy. The government has certain rights in the invention.

### TECHNICAL FIELD

The disclosure relates generally to ternary oxide materials used in electrochemical cells, such as ternary oxide materials used in solid oxide electrolysis cells or solid oxide fuel cells. More specifically, the disclosure relates to a ternary oxide material that includes an alkali metal or an alkaline earth metal, a platinum group metal, and oxygen.

### BACKGROUND

High temperature solid oxide fuel cells (SOFCs) offer one of the promising technologies for producing electrical energy. These cells provide multiple advantages, such as high efficiency, reliability, modularity, fuel adaptability, generation of very low levels of oxides of nitrogen and sulfur, and greater tolerance towards impurity elements, over some conventional energy conversion systems. The SOFCs are similar to solid oxide electrolysis cells (SOECs) that are operated in a “reverse” mode. The SOECs are used to electrochemically convert steam, carbon dioxide or both to hydrogen, carbon monoxide or a mixture of carbon monoxide and hydrogen (also known as syngas), respectively. The hydrogen is stored and reconverted into electricity using the SOFCs when demand arises.

Multiple SOFCs may be stacked and electrically coupled to produce a desired electrical power output of a system containing the SOFCs. The individual SOFCs of the system are stacked and electrically coupled to one another using interconnectors. The interconnectors are formed from a ceramic material, such as a perovskite oxide, or from a metallic material. The ceramic material is used in high temperature applications for SOFCs, while the metallic materials are used in intermediate temperature applications for SOFCs. The interconnectors may be formed from a doped lanthanum chromite-based material, such as doped lanthanum chromite (LaCrO₃). Forming the doped lanthanum chromite interconnector materials uses complicated solid-state diffusion processes that are conducted at high temperature. Interconnectors formed from other materials, such as iron- or chromium-based alloys, have also been investigated. However, the efficacy of the ceramic materials is dependent on temperature, oxygen partial pressure, type of dopant, and amount of dopant. For instance, the doped lanthanum chromite interconnector materials have reduced functionalities at a temperature range of between 600° C. and 800° C. and are sensitive towards oxygen partial pressure. The metallic interconnect materials are not functional at temperatures above 800° C.

### SUMMARY

An electrochemical cell is disclosed and comprises an anode, an electrolyte adjacent to the anode, a cathode adjacent to the electrolyte, and an interconnector adjacent to the cathode. One or more of the anode, the cathode, and the interconnector comprises a ternary oxide material comprising the chemical formula of M¹ₓM²_{y}O_{z}, where M¹ is an alkali metal element or an alkaline earth metal element, M² is a platinum group metal, each of x and y is independently an integer less than or equal to 2, and z is independently an integer less than or equal to 4.

A system is disclosed and comprises one or more electrochemical cells separated from one another by an interconnector. Each of the electrochemical cells comprises an anode, an electrolyte adjacent to the anode, and a cathode adjacent to the electrolyte. One or more of the anode, the cathode, and the interconnector comprises a ternary oxide material comprising the chemical formula of M¹ₓM²_{y}O_{z}, where M¹ is an alkali metal element or an alkaline earth metal element, M² is a platinum group metal, each of x and y is independently an integer less than or equal to 2, and z is independently an integer less than or equal to 4.

A method of forming a ternary oxide material is also disclosed. The method comprises exposing an anode comprising a platinum group metal and a cathode comprising an oxide of a transition metal to a molten salt electrolyte. The molten salt electrolyte comprises an alkali metal halide or an alkaline earth metal halide and an oxide of the alkali metal or the alkaline earth metal. An electrical current is applied between the anode and the cathode to form the alkali metal or the alkaline earth metal on the anode and produce oxygen gas. The alkali metal or the alkaline earth metal is annealed to form the ternary oxide on the anode. The ternary oxide material comprises atoms of oxygen, atoms of the platinum group metal, and atoms of the alkali metal or the alkaline earth metal. The ternary oxide material is recovered.

Another method of forming a ternary oxide material is disclosed and comprises combining a first metal oxide and a second metal in a crucible containing a bromide salt electrolyte or a chloride salt electrolyte. The first metal comprises an alkali metal or an alkaline earth metal and the second metal comprises a platinum group metal. The crucible is heated to form a molten bromide salt electrolyte or a molten chloride salt electrolyte. The molten salt electrolyte comprises an alkali metal or an alkaline earth metal. The first metal oxide and the second metal are reacted to form a ternary oxide material that comprises atoms of oxygen, atoms of the platinum group metal, and atoms of the alkali metal or the alkaline earth metal. The ternary oxide material is recovered.

### BRIEF DESCRIPTION OF THE DRAWINGS

FIGS. 1A and 1B are cross-sectional schematic illustrations of an apparatus during various processing acts to form the ternary oxide material in accordance with embodiments of the disclosure by a chemical process.

FIG. 2A is a schematic illustration of a system that includes multiple solid oxide fuel cells (SOFCs) including one or more of interconnectors or electrodes including the ternary oxide material according to embodiments of the disclosure.

FIG. 2B is a schematic illustration of a SOFC of the system of FIG. 2A.

FIG. 2C is a schematic illustration of a solid oxide electrolysis cell (SOEC) including one or more of interconnectors or electrodes including the ternary oxide material according to embodiments of the disclosure.

FIG. 3 is a plot showing conductivity vs. inverse of temperature of lithium iridate and lithium platinate in accordance with embodiments of the disclosure.

### DETAILED DESCRIPTION

A ternary oxide material used as an interconnector or as an electrode material of an electrochemical cell is disclosed. In addition to oxygen atoms, the ternary oxide material includes atoms of an alkali/alkaline earth metal element of the periodic table of the elements and atoms of a platinum group metal element from the periodic table of the elements. One or more components, such as the interconnector or the electrode material, of the electrochemical cell may be formed from the ternary oxide material. The component(s) formed from the ternary oxide material may exhibit increased electrical conductivity, thermal conductivity, and thermal stability compared to conventional doped lanthanum chromite-based materials. The ternary oxide material may be used as the interconnector of the electrochemical cell, as the electrode material (e.g., an anode, a cathode, a reference electrode) of the electrochemical cell, or as more than one of the interconnector, the anode, the cathode, or the reference electrode of the electrochemical cell. The ternary oxide material may be formed by an electrochemical process or by a chemical process that is relatively inexpensive compared to conventional processes of forming ternary oxide material.

As used herein, the singular forms “a,” “an,” and “the” are intended to include the plural forms as well, unless the context clearly indicates otherwise.

As used herein, “and/or” includes any and all combinations of one or more of the associated listed items.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped, etc.) and the spatially relative descriptors used herein interpreted accordingly.

As used herein, the term “ternary oxide material” means and includes a material having a chemical composition that includes atoms of three elements, one of which is oxygen. A component formed from the ternary oxide material may include one or more ternary oxide materials, such as one or more layers of the ternary oxide material.

The following description provides specific details, such as material types, material characteristics, and processing conditions in order to provide a thorough description of embodiments described herein. However, a person of ordinary skill in the art will understand that the embodiments disclosed herein may be practiced without employing these specific details. Indeed, the embodiments may be practiced in conjunction with conventional fabrication techniques employed in the electrochemical fuel cell (e.g., oxide fuel cell) industry. In addition, the description provided herein does not form a complete description of a solid oxide fuel cell or a complete process flow for manufacturing solid oxide fuel cell devices and the structures described below do not form a complete oxide fuel cell device. Only those process acts and structures necessary to understand the embodiments described herein are described in detail below.

Drawings presented herein are for illustrative purposes only and are not meant to be actual views of any particular material, component, structure, or system. Variations from the shapes depicted in the drawings as a result, for example, of manufacturing techniques and/or tolerances, are to be expected. Thus, embodiments described herein are not to be construed as being limited to the particular shapes as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are also not necessarily to scale. Additionally, elements common between figures may retain the same numerical designation.

The ternary oxide material may have a general formula of M¹ₓM²_{y}O_{z}, where M¹ is the alkali metal or alkaline earth metal, M² is the platinum group metal, each of x and y is independently an integer less than or equal to 2, and z is independently an integer less than or equal to 4. The values for x, y, and z, when multiplied by the ionic species, add up to zero. By way of example only, the ternary oxide material may have a general formula of M¹₂M²O₃ or M¹M²O₃. The ternary oxide material may also include a combination of two or more of the M¹₂M²O₃ or M¹M²O₃, such as M¹₂M²O₃/M¹₂M²O₃, M¹₂M²O₃/M¹M²O₃, or M¹M²O₃/M¹M²O₃. By appropriately selecting M¹ and M², electrical conductivity and thermal stability properties of the ternary oxide material in various environments (e.g., oxygen (O₂), nitrogen (N₂), or air) may be tailored. The ternary oxide material may optionally include one or more noble metals.

The alkali/alkaline earth metal (e.g., M¹) of the ternary oxide material may include, but is not limited to, lithium (Li), sodium (Na), potassium (K). rubidium (Rb), cesium (Cs), francium (Fr), beryllium (Be), magnesium (Mg), calcium (Ca), strontium (Sr), barium (Ba), radium (Ra), or a combination thereof. In some embodiments, M¹ is lithium. In other embodiments, M¹ is calcium. In yet other embodiments, M¹ is sodium. In still other embodiments, M¹ is strontium.

The platinum group metal (e.g., M²) of the ternary oxide material may include, but is not limited to, ruthenium (Ru), rhodium (Rh), palladium (Pd), osmium (Os), iridium (Jr), platinum (Pt), an alloy thereof, a combination of two or more of the platinum group metals, or a combination of an alloy of two or more of the platinum group metals. In some embodiments, M² is iridium. In other embodiments, M² is ruthenium. In yet other embodiments, M² is rhodium. In additional embodiments, M² is palladium. In further embodiments, M² is platinum.

The ternary oxide material may include, but is not limited to, calcium iridate (CaIrO₃), calcium platinate (CaPtO₃), calcium ruthenate (CaRuO₃), lithium iridate (Li₂IrO₃), lithium palladate (Li₂PdO₃), lithium platinate (Li₂PtO₃), lithium rhodinate (Li₂RhO₃), lithium ruthenate (Li₂RuO₃), sodium iridate (Na₂IrO₃), sodium nickelate (NaNiO₂), strontium iridate (Sr₂IrO₄), or a combination thereof. In some embodiments, the ternary oxide material is Li₂IrO₃. In other embodiments, the ternary oxide material is CaIrO₃. In yet other embodiments, the ternary oxide material is Li₂RuO₃. In additional embodiments, the ternary oxide material is Li₂RuO₃/CaIrO₃.

The ternary oxide material does not include a dopant element to provide a desired electrical conductivity. Instead, the electrical conductivity of the ternary oxide material according to embodiments of the disclosure is sufficiently high to function as the interconnector or as the electrode material without utilizing a dopant element. The electrical conductivity of the ternary oxide material may be similar to that of a semiconductive material or of a metallic material and may also be independent of temperature. The desired electrical conductivity may be achieved at an intermediate operating temperature (e.g., from about 600° C. to less than or equal to about 800° C.) or at a high operating temperature (e.g., from greater than about 800° C. to about 1255° C.) of a system containing one or more components formed from the ternary oxide material. Therefore, the ternary oxide material according to embodiments of the disclosure exhibits the electrical conductivity properties similar to those of a semiconductive material or of a metallic material and exhibits these properties across a wider operating temperature range than conventional doped lanthanum chromite-based materials, which require a dopant or multiple dopants for the enhancement of the electrical conductivities. Moreover, the electrical conductivities of the conventional doped lanthanum chromite-based materials are not independent of temperature.

The ternary oxide material may be thermally stable at a temperature greater than or equal to about 600° C., greater than or equal to about 700° C., greater than or equal to about 800° C., greater than or equal to about 900° C., greater than or equal to about 1000° C., greater than or equal to about 1100° C., or greater than or equal to about 1200° C. By way of example, the ternary oxide material may be thermally stable at a temperature of from about 600° C. to about 1255° C. Therefore, the ternary oxide material may be used to form components of electrochemical cells that are configured to operate at the intermediate temperature (e.g., from about 600° C. to less than or equal to about 800° C.) or at the high temperature (e.g., from greater than about 800° C. to about 1255° C.). The ternary oxide material may, for example, exhibit a thermal stability in O₂, N₂, or air at or above about 1100° C., at or above about 1200° C., or at or above about 1255° C. The ternary oxide material may exhibit a reduced thermal stability in a forming gas (e.g., H₂:N₂ at about 5:95 vol. %) at or above about 275° C. By way of example, the ternary oxide material may exhibit a reduced thermal stability in the forming gas at or above about 350° C. In low hydrogen content environments, the ternary oxide material may maintain its structural integrity.

The ternary oxide material according to embodiments of the disclosure may exhibit an electrical conductivity characteristic of a semiconductive material, which obeys Arrhenius law

$$σ = {σ}_{0} {e}^{- \frac{{E}_{a}}{{K}_{B} T}} ,$$

where σ is the electrical conductivity, Eₐ is activation energy, K_{B} is the Boltzmann constant, T is temperature (in Kelvin), and σ₀ is the pre-exponential factor. The Eₐ of the ternary oxide material may be less than or equal to about 1 eV. By way of example, the Eₐ of the ternary oxide material may be less than or equal to about 0.92 eV. Alternatively, the ternary oxide material according to embodiments of the disclosure may exhibit an electrical conductivity characteristic of a metallic material. For example, the ternary oxide material may exhibit an Eₐ that is near or equal to about 0 eV, such that the electrical conductivity may not substantially change with changing temperature.

The ternary oxide material according to embodiments of the disclosure also exhibits high strength, mechanical stability, and phase stability in oxygen (O₂), nitrogen (N₂), hydrogen (H₂), or air atmospheres at the intermediate operating temperatures or at the high operating temperatures. The ternary oxide material is also relatively chemically inert to (e.g., substantially unreactive with) neighboring or adjacent components of the system containing one or more components formed from the ternary oxide material. In other words, no interdiffusion occurs between the ternary oxide material and materials of the adjacent components of the electrochemical cells. The ternary oxide material is also chemically inert to (e.g., substantially unreactive with) a molten salt in a temperature range of from about 650° C. to about 900° C. Additionally, the ternary oxide material remains unchanged in the presence of sulfur. In other words, the ternary oxide material exhibits chemical inertness towards sulfur. The ternary oxide material according to embodiments of the disclosure also exhibits good resistance to creep deformation.

In addition to the high electrical conductivity and high thermal stability, the ternary oxide material according to embodiments of the disclosure exhibits sufficient dimensional, microstructural, chemical stability, thermal conductivity, and phase stability at the operating temperature of the system containing the ternary oxide material. The ternary oxide material also exhibits low permeability towards oxygen and hydrogen. The ternary oxide material is also resistant to oxidation, sulfidation, and carburization and to damage by high oxygen pressures.

The components formed from the ternary oxide material 120 may, for example, be used in electrochemical cells, metal-oxygen batteries, metal-air batteries, fuel cells, electrowinning cells, or electrorefining cells. The components of the electrochemical cells, such as the interconnector or the electrode material, formed from the ternary oxide material exhibit high temperature properties, as well as high thermal conductivities and high electrical conductivities. The ternary oxide material may also be used in combination with a quaternary oxide material in the components.

Solid oxide electrolysis cells (SOECs) or solid oxide fuel cells (SOFCs) containing the components formed from the ternary oxide material 120 provide a high combined heat and power efficiency as well as increased efficiency and lifetime to the system containing the components. The SOECs or SOFCs may be collectively referred to herein as electrochemical cells. The electrochemical cell components according to embodiments of the disclosure may, therefore, be used in high temperature applications or in intermediate temperature applications. With the ternary oxide material according to embodiments of the disclosure, a single ternary oxide material may be operable for use as the interconnector and/or as the electrode material in the high temperature applications and in the intermediate temperature applications. In contrast, no single conventional, interconnector material is operable at temperatures of from about 600° C. to about 1255° C. For comparison, conventional interconnectors formed from lanthanum chromite-based materials have reduced functionality at intermediate operation temperatures, such as from about 600° C. to less than or equal to about 800° C. Therefore, the components including the ternary oxide material according to embodiments of the disclosure may be used in applications spanning an operating temperature of from about 600° C. to about 1255° C. and are more versatile across a wide range of operating temperatures than conventional SOFCs, which lack components formed from the ternary oxide material.

The electrochemical cell components formed from the ternary oxide material according to embodiments of the disclosure exhibits high electrical conductivity, high thermal conductivity, and sufficient dimensional, microstructural, thermal stability, chemical stability, and phase stability at the operating temperature of the system containing the electrochemical cell components. The electrochemical cell components also exhibit low permeability towards oxygen and hydrogen to minimize direct combination of oxidant and fuel during use and operation of the SOECs or the SOFCs. The interconnector or the electrode material formed from the ternary oxide material also has a thermal expansion coefficient that is comparable to the thermal expansion coefficient of other (e.g., non-ternary oxide material) electrodes and electrolytes of the system. The interconnector or the electrode material is also resistant to oxidation, sulfidation, and carburization and to damage by high oxygen pressures.

The SOECs or the SOFCs including the interconnector or the electrode material exhibit increased efficiency and improved lifetime compared to conventional SOECs or conventional SOFCs including conventional interconnectors or conventional electrode materials. The SOECs or the SOFCs according to embodiments of the disclosure also exhibit longer-term stability than SOECs or SOFCs including conventional interconnectors or electrode materials. Using the ternary oxide material in the electrochemical cells as the interconnector or as the electrode material may enable the interconnector or the electrode material to exhibit improved thermal conductivities and improved electrical conductivities compared to using conventional materials in electrochemical cells. The conventional interconnectors also exhibit significant degradation at relatively low oxygen partial pressures and a strong dependence on the chemistry of a dopant element and its/their concentration(s). In contrast, the SOECs or the SOFCs including the ternary oxide material according to embodiments of the disclosure exhibit an improved stability in a highly oxidizing atmosphere up to a temperature of about 1255° C. Since the ternary oxide material according to embodiments of the disclosure is stable in the highly oxidizing atmosphere, conductivity properties of the interconnector or of the electrode material are improved compared to SOFCs including conventional interconnectors and electrode materials. Therefore, the conductivity (metallic conductivity) properties of the interconnector or the electrode material may be independent of temperature. To further improve properties of the ternary oxide material in a reducing environment, a metal coating, such as aluminum or nickel, may optionally be formed on the ternary oxide material.

The ternary oxide material may be formed by an electrochemical process or by a chemical process. The electrochemical and chemical processes of forming the ternary oxide material according to embodiments of the disclosure may be relatively low cost compared to conventional processes of forming doped lanthanum chromite-based interconnectors, which are conducted at high temperatures and include complicated solid-state diffusion processes. Although the ternary oxide material contains a platinum group metal, the processes of forming the ternary oxide material are relatively inexpensive compared to processes of forming conventional doped lanthanum chromite-based interconnectors. The electrochemical and chemical processes may also be more environmentally friendly than conventional processes because no dangerous gases are produced and salts recovered from the processes may be recycled. The electrochemical and chemical processes of forming the ternary oxide material according to embodiments of the disclosure may also be easily scalable to industrial scale by increasing the batch size or making the synthesis process semi-continuous. The ternary oxide material formed by the electrochemical process or by the chemical process may be substantially homogeneous in chemical composition. In other words, other phases of the ternary oxide material may be present at less than or equal to about 1000 parts per million (ppm).

The ternary oxide material may be formed by the electrochemical process using a molten salt electrolyte that contains one or more components of the ternary oxide material. The electrochemical process may use bromide salts or chloride salts, and a metal oxide, such as an alkali/alkaline earth metal oxide or a transition metal oxide. The metal oxide may include, but is not limited to, lithium oxide, calcium oxide, nickel oxide, chromium oxide, manganese oxide, or titanium oxide and functions as the cathode. The molten salt electrolyte may include, but is not limited to, a molten bromide salt electrolyte or a molten chloride salt electrolyte. The electrochemical process is a molten salt process that forms the ternary oxide material by immersing an anode formed of and including the platinum group metal M² and a cathode formed of and including the metal oxide into the molten salt electrolyte containing the alkali/alkaline earth metal M¹. An electrical current may be passed between the cathode and the anode to simultaneously deposit the alkali/alkaline earth metal M¹ and evolve oxygen gas on a surface of the anode. The applied electrical current may be within from about 1.0 A to about 4.0 A. The anode containing the platinum group metal M², evolved oxygen gas, and electrodeposited alkali/alkaline earth metal M¹ may chemically react to form the ternary oxide material in situ. In other words, the electrochemical process may utilize the simultaneous deposition of the alkali metal/alkaline earth metal M¹ and evolution of oxygen on the platinum group metal M². In some embodiments, lithium or calcium is deposited simultaneously with the evolution of oxygen on iridium or on ruthenium. The ternary oxide material may, therefore, be produced by a molten salt assisted in situ process. The ternary oxide material may be cleaned and annealed prior to further use in the components of the electrochemical cells. Alternatively, the ternary oxide material may be recovered (e.g., scraped) from the anode and processed separately as a monolithic structure. A molten salt annealing process may be used to produce the ternary oxide material. By way of example, the molten salt annealing process may be conducted at a temperature as low as about 650° C.

In the electrochemical process, a system is used that includes a cathode, an anode, and the molten salt electrolyte. By way of non-limiting example, the molten salt electrolyte (e.g., the molten salt) may be formed of and include a molten chloride salt (e.g., molten lithium chloride (LiCl), molten sodium chloride (NaCl), molten calcium chloride (CaCl₂), a combination of molten sodium chloride and molten calcium chloride), a molten bromide salt (e.g., molten lithium bromide (LiBr), molten potassium bromide (KBr), molten calcium bromide (CaBr₂), molten sodium bromide (NaBr), molten magnesium bromide (MgBr₂), a combination of molten sodium bromide and molten calcium bromide), or a mixed molten salt (e.g., a mixture of at least one molten chloride salt and at least one molten bromide salt)). In some embodiments, the molten salt electrolyte is a LiCl—Li₂O/CaCl₂—CaO/LiBr—Li₂O/CaBr₂—CaO electrolyte. By way of non-limiting example, the cathode may be formed of and include NiO, TiO, MnO, or UO₂. By way of non-limiting example, the anode may be formed of and include Ru, Rh, Pd, Os, Ir, Pt, an alloy, or a combination thereof.

If, for example, the anode is formed of iridium, the molten salt electrolyte is formed of LiCl with 1 wt. % Li₂O, and the cathode is formed of nickel oxide, Li₂IrO₃ may be formed as the ternary oxide material by the electrochemical process. The molten salt electrolyte may be heated to a temperature of about 650° C. for about 40 hours. During this time, a direct current or voltage may be applied between the cathode and anode to form the Li₂IrO₃ by the electrochemical process. The anode is chemically reacted to form the Li₂IrO₃ on the anode surface. The Li₂IrO₃ may have an electrical conductivity of about 0.01 S cm′ when measured at high temperatures (e.g., between 600° C. and about 1000° C.) and remains substantially the same when measured at lower temperatures (e.g., between about 200° C. and about 600° C.).

If, for example, the anode is formed of iridium, the molten salt electrolyte is formed of CaCl₂ having between about 1 wt. % CaO and about 3 wt. % CaO, and the cathode is formed of nickel oxide, CaIrO₃ may be formed as the ternary oxide material by the electrochemical process. The molten salt electrolyte may be heated to a temperature of at least about 800° C. (e.g., between about 800° C. and about 900° C.) for about 40 hours. During this time, a direct current or voltage may be applied between the cathode and anode to form the CaIrO₃ by the electrochemical process. The anode is chemically reacted to form the CaIrO₃ on the anode surface.

If, for example, the anode is formed of iridium or ruthenium, the molten salt electrolyte is formed of LiCl—Li₂O and CaCl₂—CaO, and the cathode is formed of nickel oxide (NiO), titanium oxide (TiO), manganese oxide (MnO), or chromium oxide (Cr₂O₃), Li₂IrO₃/CaIrO₃ may be formed as the ternary oxide material by a combination of chemical and electrochemical processes. The molten salt electrolyte may be heated to a temperature of at least about 650° C. to about 900° C. (e.g., between about 800° C. and about 900° C.) for about 40 hours. During this time, a direct current or voltage may be applied between the cathode and anode to form the Li₂IrO₃/CaIrO₃ by the combined chemical and electrochemical process. The anode is chemically reacted to form the Li₂IrO₃/CaIrO₃ on the anode surface.

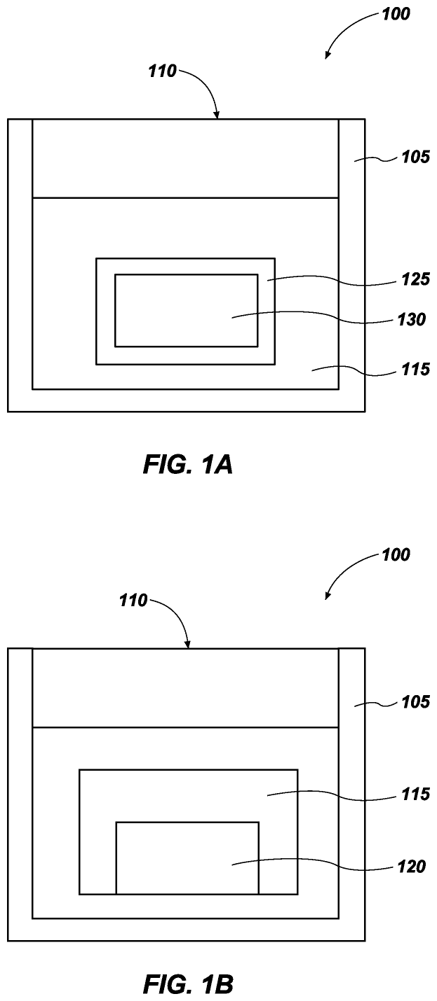

The ternary oxide material may, alternatively, be formed by the chemical process, such as by a molten salt assisted chemical process, in an apparatus 100 as shown in FIGS. 1A and 1B. The electrochemical process may be conducted in an inert environment, such as in an argon atmosphere-controlled glove box. Alternatively, the electrochemical process may be conducted in a gas-tight apparatus. The apparatus 100 includes a crucible 105, a salt bed 115, a lid 110, and a salt encapsulation 125. The apparatus 100 is configured as a sealed chamber. The sealed chamber may function as a furnace. The molten salt assisted chemical process may form the ternary oxide material 120 by encapsulation of reactants 130, such as a metal oxide (M¹ oxide) and metal M², or, optionally, of metal oxides (M¹ oxide and M² oxide) within the salt bed 115 (e.g., within the salt encapsulation 125). As shown in FIG. 1A, the reactants 130 are contained in the crucible 105 and combined. The sealed chamber is heated, allowing the chemical process to occur and to form the ternary oxide material 120, as shown in FIG. 1B. The chemical process may utilize a heat treatment of the reactants under the cover of a molten salt electrolyte, such as a molten bromide salt electrolyte or a molten chloride salt electrolyte. The ternary oxide material 120 may be formed on a substrate (not shown) as a coating. A material of the substrate may include, but is not limited to, graphite, a base metal, a transition metal, or a noble metal.

The metal oxide (M¹ oxide) may be an oxide of Li, Na, K, Rb, Cs, Fr, Be, Mg, Ca, Sr, Ba, or Ra, or a combination thereof. The M¹ oxide may, alternatively, be a carbonate compound of the previously mentioned M¹ oxide compounds. The metal M² may be Jr, Ru, Rh, Pd, Os, Pt, Ni, a combination thereof, an oxide thereof, or an alloy thereof. For instance, if an iridium oxide is used, the iridium oxide may be IrO₂, IrO₃, or Ir₂O₃. A combination of the metal M² and M² oxide may also be used.

The salt bed 115 used for encapsulation may include a salt of an alkali metal halide salt, an alkaline earth metal halide salt, an alkali metal oxide, an alkaline earth metal oxide, or a combination thereof. The salt bed 115 may, for example, be formed of and include a chloride salt (e.g., lithium chloride (LiCl), sodium chloride (NaCl), calcium chloride (CaCl₂), a combination of NaCl and CaCl₂), a bromide salt (e.g., calcium bromide (CaBr₂), sodium bromide (NaBr), potassium bromide, magnesium bromide (MgBr₂), a combination of NaBr and CaBr₂), or a mixed salt bed 115 (e.g., a combination of at least one chloride salt and at least one bromide salt, such as LiCl—NaCl—KCl, LiCl—KCl—NaCl—CaCl₂). The chloride salt or the bromide salt may be a unitary, binary, ternary or quaternary salt. In some embodiments, the salt bed 115 includes KBr. In other embodiments, the salt bed 115 includes LiCl/CaCl₂/LiBr/CaBr₂. Heating the salt bed 115 forms the molten salt electrolyte.

The M¹ oxide and metal M² or the combination of the M¹ and M² oxides may be contained (e.g., encapsulated) in the salt bed 115 of the sealed chamber. The salt bed 115 may be heated to a temperature of from about 650° C. to about 1000° C. to react the M¹ oxide and metal M² or the combination of the M¹ and M² oxides to form the ternary oxide material 120. If, for example, KBr is used as the salt bed 115, the salt bed 115 may be heated to a temperature of about 850° C. The salt bed 115 may be heated for an amount of time sufficient for the reactants 130 to react. As the reaction is initiated, the volume of the reactants 130 is reduced. During the reaction, the salt of the salt bed 115 becomes molten. The salt bed 115 may, for example, be heated for between about 24 hours and about 72 hours at a temperature of between about 800° C. and about 1000° C. The salt bed 115 may be cooled to room temperature (from about 20° C. to about 25° C.) such that the molten salt solidifies. The solidified salt is removed from the sealed chamber by dissolving the solidified salt in water and filtering the dissolved salt. Followed the filtration to remove the dissolved salt, the ternary oxide material 120 may be recovered as a powder (e.g., a free-flowing powder).

The sealed chamber may be heated for between about 24 and about 72 hours a temperature of between about 800° C. and about 1000° C. to form the ternary oxide material 120. Following the formation of the ternary oxide material 120, the ternary oxide material 120 may be isolated from the salt bed 115 and any excess material removed by water leaching and filtration.

The ternary oxide material 120 may be formed into the component(s) of the electrochemical cells by conventional techniques and the components used in a system. The electrochemical cell component may include one or more layers of the ternary oxide material 120. If multiple layers of the ternary oxide material 120 are present in the component, a chemical composition of substantially all of the layers may be the same as one another, the chemical composition of some of the layers may be different than the chemical composition of other of the layers, or the chemical compositions of substantially all of the layers may be different from one another.

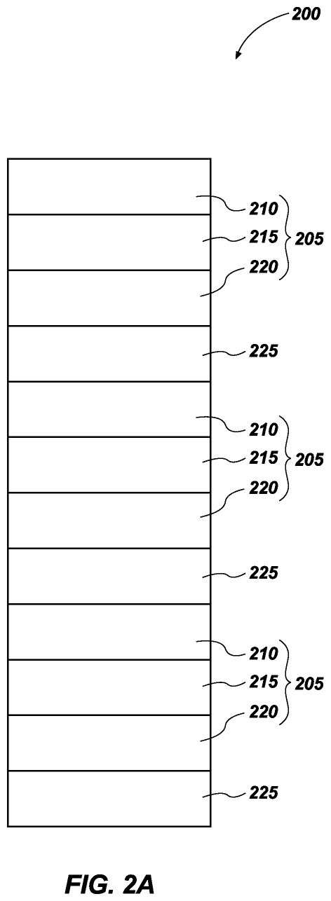

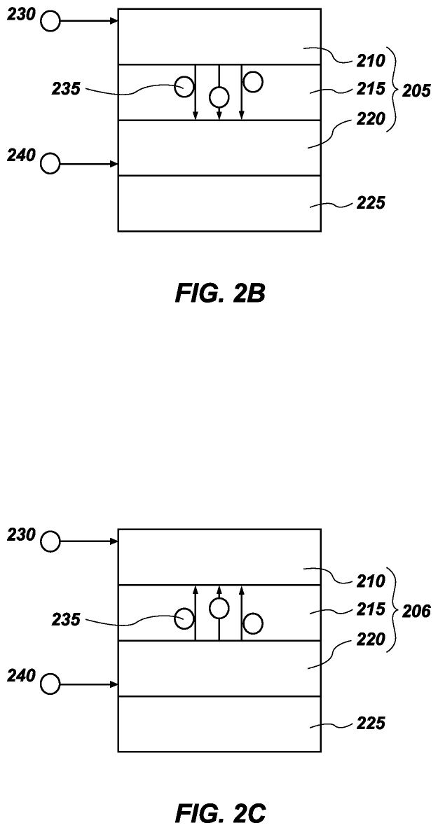

A system 200 is shown in FIG. 2A and includes a stack of multiple SOFCs 205, anode 210, electrolyte 215, cathode 220, and interconnectors 225. One or more of the interconnectors 225, the anode 210, or the cathode 220 may include the ternary oxide material 120. For example, only the interconnectors 225 may be formed of and include the ternary oxide material 120 and may be present between adjacent SOFCs 205. Alternatively, the anode 210 and the cathode 220 may be formed of and include the ternary oxide material 120, or the interconnectors 225, the anode 210, and the cathode 220 may be formed of and include the ternary oxide material 120. If two or more of the interconnectors 225, the anode 210, or the cathode 220 are formed of the ternary oxide material 120, a chemical composition of the ternary oxide material 120 for each of the interconnectors 225, the anode 210, or the cathode 220 may be the same as one another or may be different from one another. Additionally, the chemical composition of a single type of electrochemical cell component (e.g., the interconnectors 225, the anode 210, the cathode 220) in the system 200 may have the same chemical composition as one another or may have different chemical compositions from one another. By way of example only, multiple anodes 210 in the system 200 may have the same chemical composition as one another. Alternatively, the multiple anodes 210 in the system 200 may have different chemical compositions from one another.

In some embodiments, the ternary oxide material 120 of the anode 210 or of the cathode 220 is Li₂IrO₃, Li₂RuO₃, or Li₂PtO₃. In some embodiments, the ternary oxide material 120 of the interconnectors 225 is Li₂IrO₃, Li₂RuO₃, Li₂PtO₃, CaIrO₃, or Na₂IrO₃. In some embodiments, the ternary oxide material 120 is used as a reference electrode and is Li₂IrO₃, Li₂RuO₃, Li₂PtO₃, CaIrO₃, Na₂NiO₃, or Na₂IrO₃.

The individual SOFCs 205 are stacked in, for example, a vertical direction, and the interconnectors 225 are used to connect the SOFCs 205. The interconnectors 225 according to embodiments of the disclosure are used to couple multiple SOFCs to one another to maximize electrical power output of the system 200 containing the SOFCs. A single SOFC 205 and a corresponding interconnector 225 are shown in greater detail in FIG. 2B. During use and operation of the system 200 including the SOFCs 205, a fuel 230 and an oxidant gas 240 are introduced to the SOFCs 205 and oxide ions 235 are transported across the electrolyte 215 from the anode 210 side of the individual SOFC 205 to the cathode 220 side of the individual SOFC 205. Reduction of the oxidant gas 240 (e.g., oxygen, air) into the oxide ions 235 (e.g., oxygen ions) occurs at the cathode 220, and the oxide ions 235 diffuse through the electrolyte 215 to the anode 210 and electrochemically oxidize the fuel 230 and produce electrons (e⁻). The electrons are transported across the electrolyte 215 from the anode 210 side of the SOFC 205 to the cathode 220 side of the SOFC 205. The electrons flow through an external circuit to produce electrical current, which is removed from the system 200 and used to produce electrical energy.

Each SOFC 205 includes the cathode 220, the electrolyte 215, and the anode 210, with the interconnector 225 between the anode 210 of one SOFC 205 and the cathode 220 of another, adjacent SOFC 205. Each SOFC 205, therefore, includes a repeating unit of the cathode 220, the electrolyte 215, the anode 210, and the interconnector 225. The interconnector 225 connects (e.g., electrically connects) the SOFCs 205 and physically separates the anode 210 of one SOFC 205 from the cathode 220 of the adjacent SOFC 205. The interconnector 225 electrically connects the anode 210 of one SOFC 205 to the cathode 220 of the adjacent SOFC 205. The interconnectors 225 electrically connect the SOFCs 205 and complete the primary electrical circuit. In FIG. 2A, the SOFCs 205 are stacked in series. However, other configurations of the SOFCs 205 are possible. By using the ternary oxide material 120 according to embodiments of the disclosure as the material of the interconnector 225, power output of the SOFCs 205 is maximized. While three SOFCs 205 are shown in FIG. 2A, the actual number of SOFCs 205 in the system 200 may depend on a desired power output (e.g., a desired voltage output) for the system 200. The desired voltage output for the system 200 may be achieved by coupling the SOFCs 205 to one another, such as in series, using the interconnectors 225 according to embodiments of the disclosure. By way of example only, the system 200 may include from about 30 SOFCs 205 to about 100 SOFCs 205 depending on a desired gas production rate of the system 200. However, fewer or more SOFCs 205 may also be used. In addition to providing electrical contact between the adjacent SOFCs 205, the interconnectors 225 provide gas separation between the SOFCs 205 and enable gas distribution across the SOFCs 205. The system 200 may also include an input (not shown) for the fuel 230, an input (not shown) for the oxidant gas 240, and an external electrical circuit (not shown) for electrical current produced by the SOFC 205 and to be removed from the SOFC 205. In addition to being used in the interconnector 225, the ternary oxide material 120 may be used as the anode 210 and/or as the cathode 220 of the SOFC 205. Therefore, the ternary oxide material 120 is a versatile material for use in the SOFCs 205.

If only the interconnector 225 and/or the cathode 220 is formed from the ternary oxide material 120, the anode of the SOFC 205 may be a conventional anode material including, but not limited to, a nickel-yttria stabilized zirconia, lanthanum strontium manganite, platinum, or gold. Similarly, if only the interconnector 225 and/or the anode 210 is formed from the ternary oxide material 120, the cathode 220 of the SOFC 205 may be a conventional cathode material including, but not limited to, a doped lanthanum manganite, a cermet material, such as Ni-YSZ, samaria-doped ceria (Sm₂O₃—CeO₂), lithium iron phosphate (LiFePO₄), lithium cobalt oxide (LiCoO₂), or a spinel cathode (e.g., Li₂NiMn₃O₈, Li₂FeMn₃O₈, LiCoMnO₄). The electrolyte 215 of the SOFC 205 conducts oxide ions 235 (O²⁻) and may be a conventional solid electrolyte including, but not limited to, yttria/ytterbia/scandia-stabilized zirconia, doped lanthanum gallate, doped ceria, and cerate-based materials, such as BaCeO₃ or BaCe_{0.9}Gd_{0.1}O_{1.45}. In some embodiments, the interconnector 225 is formed of and includes Li₂IrO₃, Li₂RuO₃, Li₂PtO₃, Na₂IrO₃, or a combination thereof.

The interconnector 225, the anode 210, and/or the cathode 220 may be formed from the ternary oxide material 120 by conventional techniques. Conventional techniques may also be used to form the interconnector 225, the anode 210, the cathode 220, or the electrolyte 215 if materials other than the ternary oxide material 120 are used. The interconnectors 225 may be used to interconnect (e.g., electrically interconnect, electrically couple, electrically connect) multiple electrochemical cells. By way of example only, the anode 210, the cathode 220, the electrolyte 215, and the interconnector 225 may be separately formed and adjoined to one another to produce an individual SOFC 205, which is coupled to additional individual SOFCs 205 using additional interconnectors 225 to form the system 200. Or, the anode 210, the cathode 220, and the electrolyte 215 of individual SOFCs 205 may be formed and the interconnector 225 formed on the cathode 220 before placing the vertically adjacent SOFC 205 on the interconnector 225 with the anode 210 proximal to the interconnector 225.

The ternary oxide material 120 may, alternatively, be used as one or more of an anode 210, a cathode 220, or an interconnector 225 in a SOEC 206, as shown in FIG. 2C. Multiple SOECs 206 may be coupled together to form a system similar to the system 200 of SOFCs 205 shown in FIG. 2B. The multiple SOECs 206 may be stacked (e.g., vertically stacked) substantially similarly to the multiple SOFCs 205 shown in FIG. 2A. In the system including multiple SOECs 206, the ternary oxide material 120 may be used as a power source to perform electrolysis on a fuel 230 (e.g., water and or carbon dioxide) to produce an oxidant gas 240 (e.g., H₂, O₂). The components of the SOEC 206 may be formed as described above for the SOFCs 205, and configurations of the SOECs 206 in the system may be similar to those described above for the SOFCs 205.

The SOECs 206 or the SOFCs 205 including the components formed from the ternary oxide material 120 may be used in buildings, automotive, portable electronic devices, or backup power systems in data centers, telecommunications towers, hospitals, emergency response systems, or military applications. In addition to SOECs 206 or SOFCs 205, the ternary oxide material 120 may be used in other fuel cells, such as polymer electrolyte membrane fuel cells, direct methanol fuel cells, phosphoric acid fuel cells, molten carbonate fuel cells, or reversible fuel cells.

The ternary oxide material 120 may also be used in nuclear molten salt systems, nuclear-based hybrid energy systems, fission batteries, chloride-based molten salt reactors, fuel cells for solar, wind and battery power, solid oxide electrochemical cells, and solid oxide batteries. The highly conductive ternary oxide material 120 may be used as an electrode in the nuclear molten salt system, an electrode or interconnector in the nuclear-based hybrid energy system, a coating for a titanium dioxide electrode in the fission battery, an interconnector in the fuel cell, an electrode in the solid oxide electrochemical cell, or an electrode in the solid oxide battery.

The following examples serve to explain embodiments of the disclosure in more detail. These examples are not to be construed as being exhaustive or exclusive as to the scope of this disclosure.

### Example 1

Monolithic metals are exposed to lithium, calcium, ruthenium, and oxygen in the temperature range of from about 650° C. to about 900° C. to form calcium iridate, calcium ruthenate, lithium iridate, or lithium ruthenate. These compounds were formed in the form of coatings. These coatings were allowed to remain in highly corrosive molten salts for several hours (greater than 50 hours) and were subjected to oxygen bubbling on their surfaces for several hours. The exposed coatings were subsequently evaluated and characterized by chemical, phase and microstructural analyses. These preliminary experiments have indicated initial suitability and applicability of the ternary oxide materials as an improved interconnector material or electrode material for use in both high and intermediate temperature SOFCs or SOECs. Li₂IrO₃/Li₂RuO₃ have shown excellent chemical stability (resistance to degradation in the presence of bubbling oxygen on their surfaces) and constant electrical conductivity in the range of temperature from 600° C. to 1100° C.

### Example 2

Li₂CO₃ and IrO₂ were combined with an agate pestle and mortar. The mixed product was then formed into a pellet, which was covered by solid KBr in a synthesis apparatus 100 including an alumina crucible 105 with a lid 110. The alumina crucible 105 was placed in a furnace heated to a temperature of 800° C. for a duration of at least 24 hours and as long as 72 hours. The furnace was cooled to room temperature, and water was poured into the alumina crucible 105 to dissolve the solidified KBr. The alumina crucible 105 with water added was then heated to 60° C. to dissolve the salt completely. Filtration was then performed to isolate Li₂IrO₃ as the ternary oxide material from the dissolved KBr.

### Example 3

To produce Li₂PtO₃, Li₂CO₃ and PtO₂ were used as the reactants instead of Li₂CO₃ and IrO₂. The reactants were combined and reacted as described above in Example 2 for the preparation of Li₂IrO₃.

### Example 4

To produce Li₂RuO₃, Li₂CO₃ and RuO₂ were used as the reactants instead of Li₂CO₃ and IrO₂. The reactants were combined and reacted as described above in Example 2 for the preparation of Li₂IrO₃.

### Example 5

To produce Na₂IrO₃, Na₂CO₃ and IrO₂ were used as the reactants instead of Li₂CO₃ and IrO₂. The reactants were combined and reacted as described above in Example 2 for the preparation of Li₂IrO₃.

### Example 6

CaCO₃ and IrO₂ were used to prepare CaIrO₃ in a similar manner as described above in Example 2 by heating the furnace to a temperature of 900° C. for at least 24 hours and as long as 72 hours.

### Example 7

CaCO₃ and RuO₂ were used to prepare CaRuO₃ in a similar manner as described above in Example 2 by heating the furnace to a temperature of 900° C. for at least 24 hours and as long as 72 hours.

### Example 8

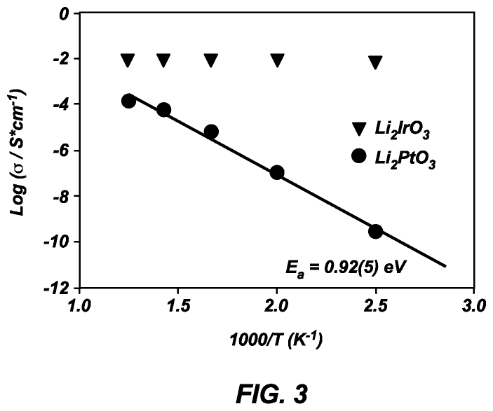

The Li₂IrO₃ exhibited an electrical conductivity of about 0.01 S cm⁻¹ when measured at high temperatures (e.g., between about 600° C. and about 1000° C.) and remained substantially the same when measured at lower temperatures (e.g., between about 200° C. and about 600° C.). As shown in FIG. 3, the Eₐ calculated from the electrical conductivity versus temperature data in FIG. 3 is substantially zero (e.g., less than about 0.005 eV) for the Li₂IrO₃. The electrical conductivity of the Li₂IrO₃ may be characterized as metallic since the conductivity does not change with temperature. The Li₂IrO₃ was determined to be stable in O₂/N₂/air up to a temperature of about 1202° C. The Li₂IrO₃ exhibited metallic behavior at intermediate and high temperatures. The Li₂IrO₃ also exhibited unchanged electrical performance in the presence of sulfur.

As also shown in FIG. 3, the Li₂PtO₃ exhibited an electrical conductivity at high temperatures (e.g., about 800° C.) of about 1e-4 S cm⁻¹, and an electrical conductivity at low temperatures (e.g., about 400° C.) of about 1e-9 S cm⁻¹. The Eₐ calculated from the electrical conductivity versus temperature data in FIG. 3 is at or less than about 0.92 eV. The electrical conductivity of the Li₂PtO₃ exhibited may be characterized as semiconductive since the electrical conductivity at higher temperatures is higher than the electrical conductivity at lower temperatures. The Li₂PtO₃ was determined to be stable in O₂/N₂/air up to a temperature of about 1102° C.

The Li₂RuO₃ also exhibited an electrical conductivity characteristic of a semiconductive material, and its electrical conductivity at higher temperatures was higher than the electrical conductivity at lower temperatures. The Li₂RuO₃ was determined to be stable in O₂/N₂/air up to a temperature of about 1252° C.

The Na₂IrO₃ exhibits an electrical conductivity characteristic of a metallic conductivity, similar to Li₂IrO₃

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

What is claimed is:

1. An electrochemical cell, comprising:
an anode, an electrolyte adjacent to the anode, a cathode adjacent to the electrolyte, and an interconnector adjacent to the cathode, one or more of the anode, the cathode, and the interconnector comprising a ternary oxide material comprising a chemical formula of M¹ₓM²_{y}O_{z}, where M¹ is an alkali metal element or an alkaline earth metal element, M² is a platinum group metal, each of x and y is independently an integer less than or equal to 2, and z is independently an integer less than or equal to 4.

2. The electrochemical cell of claim 1, wherein the alkali metal element or the alkaline earth metal element comprises one or more of lithium, sodium, potassium rubidium, cesium, francium, beryllium, magnesium, calcium, strontium, barium, or radium.

3. The electrochemical cell of claim 1, wherein the platinum group metal comprises one or more of ruthenium, rhodium, palladium, osmium, iridium, or platinum.

4. The electrochemical cell of claim 1, wherein the ternary oxide material comprises calcium iridate, calcium ruthenate, lithium iridate, lithium platinate, lithium ruthenate, or a combination thereof.

5. The electrochemical cell of claim 1, wherein the ternary oxide material lacks a dopant element.

6. A system comprising:
one or more electrochemical cells separated from one another by an interconnector, each of the electrochemical cells comprising an anode, an electrolyte adjacent to the anode, and a cathode adjacent to the electrolyte, one or more of the anode, the cathode, and the interconnector comprising a ternary oxide material comprising a chemical formula of M¹ₓM²_{y}O_{z}, where M¹ is an alkali metal element or an alkaline earth metal element, M² is a platinum group metal, each of x and y is independently an integer less than or equal to 2, and z is independently an integer less than or equal to 4.

7. The system of claim 6, wherein adjacent electrochemical cells are separated from one another by the interconnector comprising the ternary oxide material.

8. The system of claim 6, wherein the one or more electrochemical cells are separated from one another by interconnectors comprising ternary oxide materials of different chemical compositions.

9. The system of claim 6, wherein the one or more electrochemical cells are separated from one another by interconnectors comprising ternary oxide materials of the same chemical composition.

10. The system of claim 6, wherein the one or more electrochemical cells comprise one or more solid oxide fuel cells.

11. The system of claim 6, wherein the one or more electrochemical cells comprise one or more solid oxide electrolysis cells.

12. The system of claim 6, wherein the ternary oxide material is configured as a layer.

13. A method of forming a ternary oxide material, comprising:
exposing an anode comprising a platinum group metal and a cathode comprising an oxide of a transition metal to a molten salt electrolyte, the molten salt electrolyte comprising an alkali metal halide or an alkaline earth metal halide and an oxide of the alkali metal or the alkaline earth metal;
applying an electrical current between the anode and the cathode to form the alkali metal or the alkaline earth metal on the anode and produce oxygen gas;
annealing the alkali metal or the alkaline earth metal to form a ternary oxide material on the anode, the ternary oxide material comprising atoms of oxygen, atoms of the platinum group metal, and atoms of the alkali metal or the alkaline earth metal; and
recovering the ternary oxide material.

14. The method of claim 13, wherein exposing an anode comprising a platinum group metal and a cathode comprising an oxide of a transitional metal to a molten salt electrolyte comprises exposing the anode and the cathode to the molten salt electrolyte comprising one or more molten bromide salts, one or more molten chloride salts, or a combination of one or more molten chloride salts and one or more molten bromide salts.

15. The method of claim 13, wherein exposing an anode comprising a platinum group metal and a cathode comprising an oxide of an alkali metal or an alkaline earth metal to a molten salt electrolyte comprises exposing the anode and the cathode to a molten salt electrolyte comprising LiCl/LiBr—Li₂O/CaCl₂)/CaBr₂—CaO.

16. A method of forming a ternary oxide material, comprising:
combining a first metal oxide and a second metal in a crucible containing a bromide salt electrolyte or a chloride salt electrolyte, the first metal of the first metal oxide comprising an alkali metal or an alkaline earth metal and the second metal comprising a platinum group metal;
heating the crucible to form a molten bromide salt electrolyte or a molten chloride salt electrolyte, the molten bromide salt electrolyte or the molten chloride salt electrolyte comprising an alkali metal or an alkaline earth metal;
reacting the first metal oxide and the second metal to form a ternary oxide material, the ternary oxide material comprising atoms of oxygen, atoms of the platinum group metal, and atoms of the alkali metal or the alkaline earth metal; and
recovering the ternary oxide material.

17. The method of claim 16, wherein combining a first metal oxide and a second metal in a crucible comprises combining the first metal oxide and a platinum group metal oxide in the crucible.

18. The method of claim 16, wherein heating the crucible to form a molten bromide salt electrolyte or a molten chloride salt electrolyte comprises heating the crucible to a temperature of from about 650° C. to about 1000° C.

19. The method of claim 16, wherein reacting the first metal oxide and the second metal to form a ternary oxide material comprises reacting the first metal oxide and the second metal in the molten bromide salt electrolyte or in the molten chloride salt electrolyte.

20. The method of claim 16, wherein reacting the first metal oxide and the second metal to form a ternary oxide material comprises forming a coating of the ternary oxide material on a substrate.
